(19) United States
(12) Patent Application Publication
(10) Pub. No.: US 2017/0235825 A1
(43) Pub. Date: Aug. 17, 2017

(54) IDENTIFICATION OF LOCATION-BASED AMBIENT ACOUSTIC CHARACTERISTICS

(71) Applicant: Google Inc., Mountain View, CA (US)

(72) Inventor: David Robert Gordon, Shibuya-ku (JP)

(21) Appl. No.: 14/314,956

(22) Filed: Jun. 25, 2014

Related U.S. Application Data
(60) Provisional application No. 61/839,781, filed on Jun. 26, 2013.

(51) Int. Cl. G06F 17/30

(52) U.S. Cl. CPC G06F 17/30743; G06F 17/30312

(57) ABSTRACT

Methods, systems, and apparatus, including computer programs encoded on a computer storage medium, for receiving an audio signal including one or more ambient sounds recorded by a computing device; determining a location associated with the computing device; identifying one or more ambient acoustic characteristics to associate with the location based on one or more of the ambient sounds; and associating one or more of the ambient acoustic characteristics with the location.

### RELATED APPLICATIONS

This application claims the benefit of U.S. Provisional Patent Application No. 61/839,781, filed Jun. 26, 2013, which is incorporated herein by reference.

### FIELD

The present disclosure discusses identifying ambient acoustic characteristics associated with a location.

### BACKGROUND

Audio recognition applications provide users with information about an audio signal, e.g., an audio signal that contains a music track. An audio recognition application can receive the audio signal, and identify a name of a song that is playing, or an artist associated with the song.

### SUMMARY

A major consideration for many people is music and ambiance when choosing a restaurant, club, or bar. Background music or ambient noise can help influence and predict the atmosphere and clientele of an establishment. In some examples, ambient noise can include aspects of an establishment's auditory environment, e.g., music, background noise, volume, and nature sounds. Annotating map data with location characteristics identified from audio signals helps enable users to search destinations by, among other parameters, music and ambiance preferences.

In some examples, enhanced destination searches are provided utilizing such ambiance information as a part of local searches. That is, users can search for establishments based on music and ambiance preferences, e.g., local search results can show music and ambiance information for establishments. Ambient sound information can also be used to show locations where music is playing.

Innovative aspects of the subject matter described in this specification can be embodied in methods that include the actions of receiving an audio signal including one or more ambient sounds recorded by a computing device; determining a location associated with the computing device; identifying one or more ambient acoustic characteristics to associate with the location based on one or more of the ambient sounds; and associating one or more of the ambient acoustic characteristics with the location.

Other embodiments of these aspects include corresponding systems, apparatus, and computer programs, configured to perform the actions of the methods, encoded on computer storage devices.

These and other embodiments can each optionally include one or more of the following features. For instance, identifying the one or more ambient acoustic characteristics includes identifying a song, a song artist, or a music genre associated with the ambient sounds. Associating the one or more of the ambient acoustic characteristics with the location includes incrementing a count associated with the one or more ambient acoustic characteristics, for the location. Associating the one or more of the ambient acoustic characteristics with the location includes storing data indicating a time or a date when the audio signal was received by the computing device. Associating the one or more of the ambient acoustic characteristics with the location includes storing data indicating a loudness associated with the ambient sounds.

Innovative aspects of the subject matter described in this specification can be embodied in methods that further include the actions of receiving a query; determining a location associated with the query; identifying one or more ambient acoustic characteristics associated with the location; and providing a response to the query that identifies the one or more of the ambient acoustic characteristics.

Other embodiments of these aspects include corresponding systems, apparatus, and computer programs, configured to perform the actions of the methods, encoded on computer storage devices.

These and other embodiments can each optionally include one or more of the following features. For instance, identifying the one or more ambient acoustic characteristics includes identifying a song, a song artist, or a music genre. Providing the response to the query includes providing a count associated with one or more of the ambient acoustic characteristics, for the location. Providing the response to the query includes providing a count associated with one or more of the ambient acoustic characteristics that is greater than a threshold, for the location. Providing the response to the query includes providing a count associated with the song, a count associated with the song artist, and/or a count associated with the music genre, for the location. Providing the response to the query includes providing a count associated with one or more of the ambient acoustic characteristics, for the location for a time period. Providing the response to the query includes providing a count associated with one or more of the ambient acoustic characteristics that is greater than a threshold, for the location for a time period. Providing the response to the query includes providing a count associated with the song, a count associated with the song artist, and/or a count associated with the music genre, for the location for a time period. Providing the response to the query includes providing context information associated with the one or more ambient acoustic characteristics for display on a map, wherein the map corresponds to a geographical region that includes the location.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 depicts an example system for identifying ambient acoustic characteristics.

FIG. 2A depicts an example process for identifying ambient acoustic characteristics.

FIG. 2B illustrates an example process for providing a response to a query that identifies ambient acoustic characteristics.

FIG. 3 depicts an example of a map of a geographic region including identified ambient acoustic characteristics.

FIG. 4 depicts a computer device and a mobile computer device that can be used to implement the techniques described here.

### DETAILED DESCRIPTION

In some implementations, ambiance information can be stored in a geographically-indexed database that can be used to produce various reports used by a mapping application or other applications. For example, the mapping application can annotate map data for a particular location, including generating a map overlay, e.g., a map overlay of music genres within a city based on the stored ambience information. Also, for example, a “top ten” report of music tracks recently played in a music club can be generated. Additionally, users can filter location searches by noise factors such as “noisy,” “quiet,” or even “crowded,” “chatty” or “demure.”

In some examples, a user can search for ambiance-based information associated with a specific location. That is, the geographically-indexed database can be used to produce search results, e.g., in response to a query. For example, a user can generate a query such as “Where has ‘Gangnam style’ been played?” or “Where is there a quiet Thai restaurant?” A real-time response can be generated that can identify, based on the stored ambiance information, responses to such queries that satisfy the queries. In some examples, the ambiance-based information can be indexed, or stored in a knowledge graph.

In some implementations, a server computing system receives an audio signal that includes one or more ambient sounds that are recorded by a mobile computing device. Specifically, a mobile computing device, e.g., a smartphone, a tablet computing device, or a wearable computing device, records the ambient sounds and provides an audio signal based on the ambient sounds to the server computing system. In some examples, ambient sounds include music, background noises, broadcasting sounds, crowd noises, echoes, machine noises, sounds that are produced by forces of nature, etc.

In some implementations, the server computing system determines a location associated with the mobile computing device. Specifically, the mobile computing device provides, e.g., over one or more networks, location data that the mobile computing device is associated with to the server computing system. In some examples, the audio data and the location data associated with the mobile computing device is collected by the mobile computing device in response to a trigger generated by a user associated with the mobile computing device. For example, the user can initiate a query within an application running on the client computing device. The mobile computing device, the server computing system, or both, can identify one or more triggering elements within the query such that upon identification of the triggering elements, collection is commenced of the audio data and the location data. For example, the trigger elements can include identification of specific word(s) or phrases in the query.

In some implementations, the server computing system identifies one or more ambient acoustic characteristics to associate with the location of the mobile computing device based on one or more of the ambient sounds. In some examples, the ambient sounds recorded by the mobile computing device can include music. To that end, based on the musical ambient sounds, the server computing system can i) identify ambient acoustic characteristics of the music, including a song, a song artist, and/or music genre that are associated with the music, and ii) associate the ambient acoustic characteristics of the music, including a song, a song artist, and/or music genre that are associated with the music, with the location of the mobile computing device.

In some examples, identifying the ambient acoustic characteristics to associate with the location of the mobile computing device by the server computing system can be performed immediately after collection of the audio data and/or the location data by the mobile computing device. That is, in some examples, the audio data and/or the location are not retained, e.g., stored, by the server computing device. In some examples, the identified ambient acoustic characteristic associated with the location of the mobile computing device can be anonymized.

In some examples, based on the identified ambient acoustic characteristics, the server computing system can generate a tuple containing i) the location of the mobile computing device; ii) a list of ambient sounds detected with respect to the location of the mobile computing device, each sound associated with a confidence score that the ambient sound is present at the location of the mobile computing device; and iii) a score indicating a strength of the identified ambient acoustic characteristics associated with the location of the mobile computing device.

In some implementations, the server computing system associates the one or more ambient acoustic characteristics with the location of the mobile computing device. For example, associating the ambient acoustic characteristics with the location can include annotating map data of the location of the mobile computing device with the ambient acoustic characteristics identified for the location. The ambient acoustic characteristics associated with the location of the mobile computing device can be associated with search and mapping applications, such that when a user is presented with various locations on a map, the ambient acoustic characteristics are included on or accessible from the mapped locations.

In some examples, different ambient acoustic characteristics can be associated with the location associated with the mobile computing device at different times. In some examples, the location of the mobile computing device can be associated with two or more ambient acoustic characteristics over a period of time. When two or more ambient acoustic characteristics are associated with the location, the server computing system can determine, for each ambient acoustic characteristic, a count associated with the ambient acoustic characteristic, for the location. In some examples, the server computing system can designate ambient acoustic characteristics that have been associated with the location of the mobile computing device for more than a threshold number of times or ambient acoustic characteristics that have been associated with the location of the mobile computing device for the most number of times to be associated with the location.

In some examples, the server computing system can provide to the mobile computing device context information about the ambient acoustic characteristics of the location for display on a map of a geographical region that includes the location. The server computing system can also provide context information about the ambient acoustic characteristics of the location in response to receiving a search query about the location. In some examples, when a user submits a query for the location, the server computing system can provide the user with context information, e.g., a count of times that a song has played at the location.

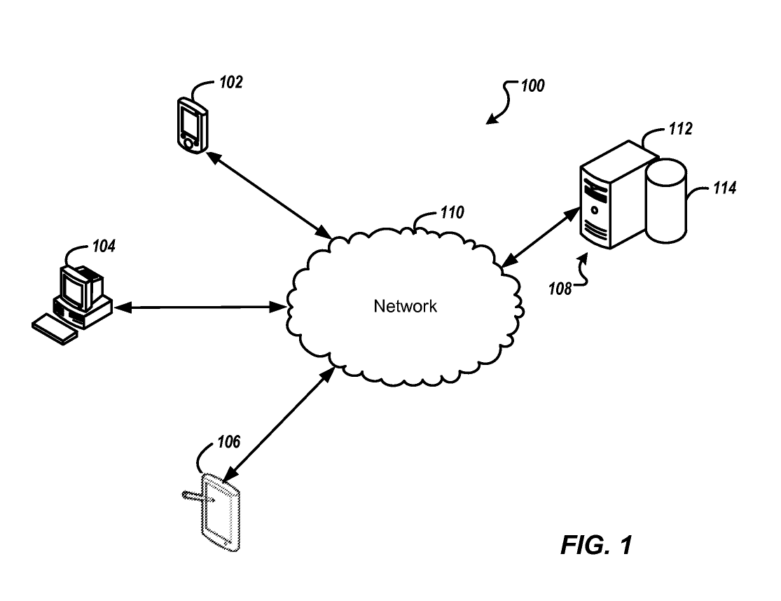

FIG. 1 depicts an example system 100 for identifying ambient acoustic characteristics. The system 100 includes computing devices 102, 104, and 106, e.g., client computing devices, that are communicably connected to a server computing system 108 by a network 110. The server computing system 108 includes a processing device 112 and a data store 114. The processing device 112 executes computer instructions stored in a computer-readable medium, for example, to appropriately process a received audio signal to identify ambient acoustic characteristics. The data store 114 includes storage systems that store the identified ambient acoustic characteristics associated with one or more locations. In some examples, the server computing device 108 can include more than one computing device working together to perform the actions of a server computer.

In some examples, the computing devices 102, 104, and 106 can include a smartphone, a tablet computing device, a wearable computing device, a personal digital assistant (PDA) computing device, a laptop computing device, a portable media player, a desktop computing device, or other computing devices. In the illustrated example of FIG. 1, the computing device 102 is a smartphone, e.g., a mobile computing device 102; the computing device 104 is a desktop computer; and computing device 106 is a PDA.

In some examples, the computing devices 102, 104, and 106 include an audio detection module, e.g., a microphone, that can detect and record ambient sounds at a respective location of the computing device. The computing devices 102, 104, and 106 can provide a respective audio signal including the ambient sounds to the server computing system 108. In some examples, the computing devices 102, 104, and 106 include a location detection module, e.g., a global positioning system (GPS) based module, to obtain location-based data associated with the respective computing device. Thus, in some examples, the computing devices 102, 104, and 106 can provide, in addition to providing the respective audio signal including the detected ambient sounds associated with the respective computing device, location-based data of the respective location of the computing device to the server computing system 108.

The network 110 can include, for example, any one or more of a cellular network, a satellite network, a personal area network (PAN), a local area network (LAN), a wide area network (WAN), a broadband network (BBN), the Internet, and the like. Further, the network 108 can include any one or more of the following network topologies, including a bus network, a star network, a ring network, a mesh network, a star-bus network, tree or hierarchical network, and the like.

In some implementations, the server computing system 108 receives an audio signal. Specifically, the server computing system 108 receives the audio signal from one of the computing devices 102, 104, and 106, e.g., from the mobile computing device 102, over the network 110. Specifically, the audio signal includes ambient sounds that are detected by the mobile computing device 102, e.g., by the audio detection module. The ambient sounds are associated with a location of the mobile computing device 102, and further include aspects of the location's auditory environment, e.g., music, background noise, and nature sounds. The server computing system 108 can receive the audio signal from the mobile computing device 102 over the network 110, e.g., in response to a request from the server computing system 108, or automatically from the mobile computing device 102.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be anonymized in one or more ways before it is stored or used, so that personally identifiable information is removed. In some examples, a user's identity may be anonymized so that no personally identifiable information can be determined for the user. Thus, the user may have control over how information is collected about him or her and used by a content server.

In some implementations, the server computing system 108 determines a location associated with the mobile computing device 102. Specifically, the server computing system 108 can receive location-based data from the mobile computing device 102, e.g., over the network 110. The server computing system 108 can receive the location-based data from the mobile computing device 102 in response to a request from the server computing system 108, or automatically from the mobile computing device 102.

The server computing system 108 processes the received audio signal to identify one or more ambient acoustic characteristics to associate with the location of the mobile computing device 102. Specifically, the server computing system 108 utilizes one or more audio signal recognition applications to appropriately process the ambient sounds of the received audio signal to identify ambient acoustic characteristics based on the ambient sounds. In some examples, the server computing system 108 can determine that the received audio signal from the mobile computing device 102 includes a music component. The server computing system 108 can process the music component to identify ambient acoustic characteristics corresponding to music that is currently playing proximate to the location of the mobile computing device 102. The server computing system 108 can identifying such ambient acoustic characteristics as a song associated with the music component, e.g., song title; a song artist associated with the music component, a musical genre associated with the music component, and other information that is typically associated with music.

In some examples, the server computing system 108 increments a count associated with the ambient acoustic characteristics for the location that the mobile computing device 102 detects the ambient sounds. The count can include a total number of times that a specific ambient acoustic characteristic was detected at the location, e.g., across one or more mobile computing devices and across one or more time periods. For example, the specific ambient acoustic characteristic can include a song associated with musical ambient sounds. To that end, the count can reflect a number of times the song has played at the location over a specific time period. For example, the server computing system 108 increments a count associated with the song “Gangnam Style” for the location each time the song is identified for the location. In some examples, the server computing system 108 increments a count associated with the song “Gangnam Style” for the location each time the song is identified for the location for a specific time period, e.g., between 10 pm-2 am.

In some examples, the server computing system 108 stores data indicating a time or a date when the audio signal was recorded by the mobile computing device 102. For example, when the audio signal can include musical ambient sounds, the time or date when the mobile computing device 102 records the musical ambient sounds can be stored, e.g., by the server computing system 108 and/or the mobile computing device 102.

In some examples, the server computing system 108 determines that the received audio signal from the mobile computing device 102 includes a loudness component. The server computing system 108 can process the loudness component to determine an ambient acoustic characteristic corresponding to a loudness of the ambient sounds at the location of the mobile computing device 102. For example, when the audio signal includes the loudness component, the server computing system 108 can identify decibel data associated with the loudness component of the audio signal.

In some implementations, the server computing system 108 associates the identified ambient acoustic characteristics with the location of the mobile computing device 102. For example, the server computing system 108 can associate a song, a song artist, and/or a music genre with the location of the mobile computing device 102. In some examples, the server computing system 108 associates one or more counts, each associated with a respective ambient acoustic characteristic, with the location that the mobile computing device 102 records the ambient sounds. For example, the server computing system 108 associates the count of number of times the song “Gangnam Style” has played for the location.

In some examples, the server computing system 108 associates a time or a date when the ambient sounds are recorded by the mobile computing device 102. For example, the server computing system 108 stores a time or date when the mobile computing device 102 records the song “Gangnam Style” at the location of the mobile computing device 102.

In some examples, the server computing system 108 associates the ambient acoustic characteristics with the location of the mobile computing device 102 for a time period. That is, the server computing system 108 associates the ambient acoustic characteristics for i) the location that the mobile computing device 102 records the ambient sounds, and for ii) a time period that the mobile computing device 102 records the ambient sounds. For example, the server computing system 108 can associate a count of times a song has played at a location over a specific time period. For example, the server computing system 108 can associate the count of times the song “Gangnam Style” has played at a location, e.g., at a bar or night club, between 10 pm-2 am on Friday and Saturday.

In some examples, the server computing system 108 associates a loudness, e.g., volume, with the location of the mobile computing device 102. That is, the server computing system 108 can associate the loudness of the ambient sounds for i) the location that the mobile computing device 102 records the ambient sounds and ii) a time period that the mobile computing device 102 records the ambient sounds. For example, the server computing system 108 can associate a decibel level, e.g., 150 decibels, of an ambient sound, e.g., the song “Gangnam Style,” for the location of the mobile computing device 102. Moreover, the server computing system 108 can further associate the decibel level of the ambient sound, e.g., the song “Gangnam Style,” for a time period, e.g., between 10 pm-2 am on Friday and Saturday.

In some implementations, the server computing system 108 receives a query. Specifically, the server computing system 108 receives the query from one of the computing devices 102, 104, and 106, e.g., from the computing device 106 over the network 110. In some examples, a user associated with the computing device 106 can provide a query associated with a location, and in some examples, the query is associated with ambient acoustic characteristics of the location. For example, the query can include such queries as “Where does Gangnam Style play;” “Does this bar play Gangnam Style;” “How loud is this bar.”

In some examples, the server computing system 108 receives a map search query from the computing device 106. Specifically, the server computing system 108 can provide for display, e.g., on a display of the computing device 106, a map of a geographic region that includes the location of the computing device 106. In some examples, the map can include context information such as the ambient acoustic characteristics that are associated with one or more locations displayed within the map. For example, the map can include, for one or more locations displayed with the map, what songs are most commonly associated with the location, what time periods the songs are most commonly associated with the location, and a loudness associated with the location for certain time periods. For example, for a nightclub location displayed on the map, the map can display adjacent the nightclub location that the song “Stayin' Alive” typically plays from 10 pm-11 pm on Saturday nights, and that the nightclub is “very loud.”

In some examples, the map displays, for one or more locations, associated ambient acoustic characteristics upon initial display of the map, e.g., prior to receiving the query from the computing device 106. In some examples, the map includes associated ambient acoustic characteristics for one or more other locations exclusive of the location of the query. In some examples, the map includes associated ambient acoustic characteristics for one or more other locations based on a current location of the computing device 106. That is, the computing device 106 can provide the current location thereof to the server computing system 108 such that the server computing system 108 provides the map based on the current location of the computing device 106. Thus, the map can include associated ambient acoustic characteristics for one or more locations proximate to the current location of the computing device 106.

In some implementations, the server computing system 108 determines a location associated with the received query from the computing device 106. In some examples, the server computing system 108 determines the location associated with the received query based on one or more located-based terms of the query. For example, the query can include terms that identify the location, e.g., the name of a nightclub. For example, the query can include “Does the Roxy nightclub in Austin play Gangnam Style?” In some examples, the query is associated with two or more locations. For example, the query can include “What nightclubs play Gangnam Style in Austin?”

In some examples, the server computing system 108 receives a current location of the computing device 106 from the computing device 106, as described above. To that end, the server computing system 108 can augment the received query from the computing device 106 with the current location of the computing device 106 to determine the location associated with the received query. For example, the query can include “Does the Roxy nightclub play Gangnam Style.” The server computing system 108 can augment the query with the current location of Austin, Tex. that is associated with the computing device 106. Thus, the server computing system 108 can determine that the query refers to the location of the Roxy nightclub in Austin, Tex.

In some implementations, the server computing system 108 identifies one or more ambient acoustic characteristics associated with the location. Specifically, the data store 114 stores a mapping, e.g., in a table or a database, between one or more locations and one or more ambient acoustic characteristics. To that end, the server computing system 108 accesses the data store 114 to identify which ambient acoustic characteristics are associated with the location associated with the query, e.g., via the mapping.

In some examples, the server computing system 108 identifies a song, a song artist, and/or a music genre associated with the location associated with the query. That is, the data store 114 stores mappings between one or more locations and songs, song artists, and music genres. For example, for the query that identifies the location of the Roxy Nightclub in Austin, Tex., the server computing system 108 identifies the associated ambient acoustic characteristics that the song “Gangnam Style” plays between 10 pm-2 am on Friday and Saturday.

In some implementations, the server computing system 108 provides a response to the query to the computing device 106 over the network 110. Specifically, the server computing system 108 provides the response that identifies the ambient acoustic characteristics that are associated with the location of the query. For example, in response to the query “Does the Roxy nightclub play Gangnam Style,” the server computing system 108 provide the response of “Gangnam Style plays at the Roxy nightclub between 10 pm-2 am on Friday and Saturday.” However, other substantially similarly phrased responses can be provided.

In some examples, the server computing system 108 provides a map-based response to a map search query to the computing device 106 over the network 110. That is, the server computing system 108 can update the map provided to the computing device 106 such that the context information displayed adjacent to one or more locations of the map search query is updated to include the map-based response. For example, in response to the query “What nightclubs play Gangnam Style,” the server computing system 108 updates the map to identify one or more locations that play the song “Gangnam Style,” and further updates the context information adjacent the one or more locations to include ambient acoustic characteristics such as a time/date the song is played.

In some examples, the server computing system 108 can further provide with the response a count associated with one or more of the ambient acoustic characteristics, for the location. The count provided with the response can be associated with a song, a song artist, and/or a music genre, for the location. In some examples, the server computing system 108 can provide with the response a count of times a song has played at a location. For example, in response to the query “Does the Roxy nightclub play Gangnam Style,” the server computing system 108 can provide the count of times the song “Gangnam Style” has played at the Roxy nightclub overall.

In some examples, the server computing system 108 can provide with the response a count associated with one or more of the ambient acoustic characteristics, for the location for a time period. The count provided with the response can be associated with a song, a song artist, and/or a music genre, for the location for the time period. In some examples, the server computing system 108 can provide with the response a count of times a song has played at a location over a time period. For example, in response to the query “Does the Roxy nightclub play Gangnam Style,” the server computing system 108 can provide the count of times the song “Gangnam Style” has played at the Roxy nightclub between the hours of 10 pm-2 am on Fridays and Saturdays. Moreover, in response to the query “Does the Roxy nightclub play Gangnam Style,” the server computing system 108 provides the response of “Gangnam Style typically plays at the Roxy nightclub 3 times between 10 pm-2 am on Friday and Saturday.” Furthermore, in response to the query “Does the Roxy nightclub play Gangnam Style,” the server computing system 108 provide the response of “Gangnam Style has played at the Roxy nightclub 55 times between 10 pm-2 am on Friday and Saturday over the past year.” However, other substantially similarly phrased responses can be provided.

In some examples, the server computing system 108 can further provide with the response a count associated with one or more of the ambient acoustic characteristics that is greater than a respective threshold, for the location. Specifically, the server computer system 108 can compare the count associated with one or more of the ambient acoustic characteristics with a respective threshold. In some examples, based on the comparison, the server computing system 108 determines that the count of one or more of the ambient acoustic characteristics is greater than the respective threshold. Thus, the server computing system 108 can provide with the response the count of the one or more of the ambient acoustic characteristics that is greater than the respective threshold to the computing device 106.

For example, for the query “Does the Roxy nightclub play Gangnam Style,” the server computing system 108 can compare a count of the number of times the song “Gangnam Style” has played at the Roxy nightclub with an associated threshold. Continuing, the server computing system 108 determines that the count of the number of times the song “Gangnam Style” has played at the Roxy nightclub, e.g., 60, is greater than the associated threshold, e.g., 50. Thus, the server computing system 108 can provide with the response the count associated with the number of times the song “Gangnam Style” has played the Roxy nightclub. For example, in response to the query “Does the Roxy nightclub play Gangnam Style,” the server computing system 108 provides the response of “Gangnam Style has played at the Roxy nightclub 60 times.” However, other substantially similarly phrased responses can be provided.

In some examples, the server computing system 108 can further provide with the response a count associated with one or more of the ambient acoustic characteristics that is greater than a respective threshold, for the location for a time period. Specifically, the server computer system 108 can compare the count associated with one or more of the ambient acoustic characteristics, for a time period, with a respective threshold. In some examples, based on the comparison, the server computing system 108 determines that the count of one or more of the ambient acoustic characteristics, for the time period, is greater than the respective threshold. Thus, the server computing system 108 can provide with the response the count of the one or more of the ambient acoustic characteristics, for the time period that is greater than the respective threshold to the computing device 106.

For example, for the query “Does the Roxy nightclub play Gangnam Style,” the server computing system 108 can compare a count of the number of times the song “Gangnam Style” has played at the Roxy nightclub for a time period with an associated threshold. Continuing, the server computing system 108 determines that the count of the number of times the song “Gangnam Style” has played at the Roxy nightclub between 10 am-2 pm on Friday and Saturday, e.g., 55, is greater than the associated threshold, e.g., 50. Thus, the server computing system 108 can provide with the response the count associated with the number of times the song “Gangnam Style” has played the Roxy nightclub for the time period. For example, in response to the query “Does the Roxy nightclub play Gangnam Style,” the server computing system 108 provides the response of “Gangnam Style has played at the Roxy nightclub 55 times between 10 pm-2 am on Friday and Saturday.” However, other substantially similarly phrased responses can be provided.

In some examples, the threshold can be manually set by an administrator associated with the server computing system 108, or can be dynamically determined based on historical data. In some examples, the historical data can include data of previous interactions by a plurality of users with respect to responses to queries. However, the threshold can be based on other factors as well. To that end, in some examples, the threshold associated with each ambient acoustic characteristic can differ. For example, for the count associated with a song can be compared to a first threshold, while the count associated with a song artist can be compared to a second, different threshold.

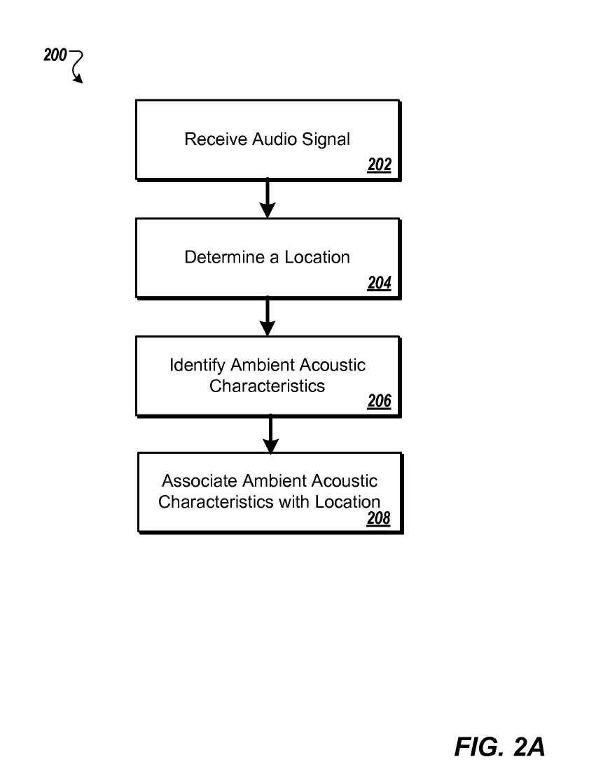

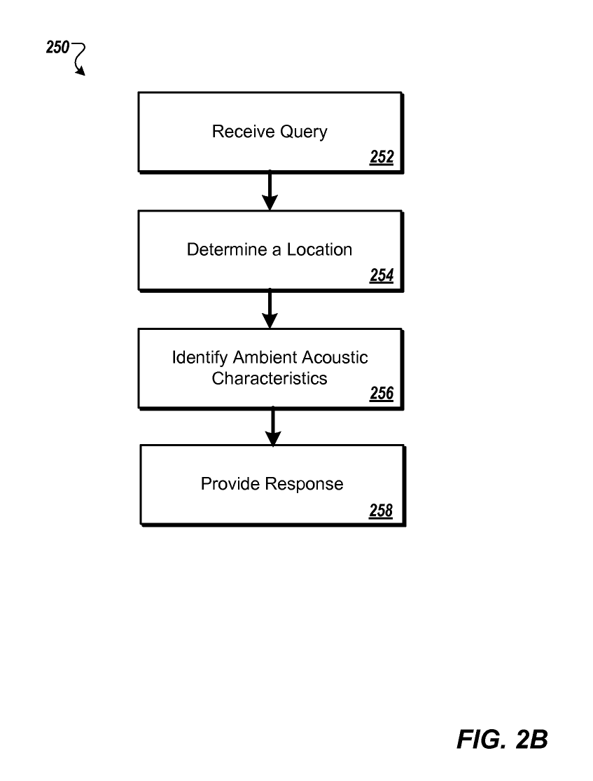

FIG. 2A illustrates an example process 200 for identifying ambient acoustic characteristics. The example process 200 can be executed using one or more computing devices. For example, the mobile computing device 102 or the server computing system 108 can be used to execute the example process 200.

The server computing system 108 receives an audio signal from the mobile computing device 102 (202). In some examples, the audio signal includes one or more ambient sounds recorded by the mobile computing device 102. Examples of ambient sounds include, but are not limited to, music, background noises, broadcasting sounds, crowd noises, echoes, machine noises, sounds that are produced by forces of nature, etc. The server computing system 108 determines a location associated with the mobile computing device 102 (204). For example, the mobile computing device 102 provides location-based data, e.g., GPS-data, to the server computing system 108.

The server computing system 108 identifies one or more ambient acoustic characteristics to associate with the location of the mobile computing device 102 (206). In some examples, the server computing system 108 identifies the ambient acoustic characteristics based on the ambient sounds of the audio signal received from the mobile computing device 102. For example, the ambient sounds of the audio signal can correspond to music, and the ambient acoustic characteristic can include a song title, a song artist, and a music genre. The server computing system 108 associates one or more of the ambient acoustic characteristics with the location (208). For example, the server computing system 108 can associate a song, a song artist, and/or a music genre with the location of the mobile computing device 102.

FIG. 2B illustrates an example process 250 for providing a response to a query that identifies ambient acoustic characteristics. The example process 200 can be executed using one or more computing devices. For example, the computing device 106 or the server computing system 108 can be used to execute the example process 250.

The server computing system 108 receives a query (252). In some examples, a user associated with the computing device 106 provides the query over the network 110. In some examples, the query is associated with ambient acoustic characteristics of a location. The server computing system 108 determines a location associated with the query (254). In some examples, the server computing system 108 determines the location associated with the received query based on one or more located-based terms of the query. In some examples, the server computing system 108 determines a current location of the computing device 106 and augments the received query from the computing device 106 with the current location of the computing device 106 to determine the location associated with the received query.

The server computing system 108 identifies one or more ambient acoustic characteristics associated with the location (256). In some examples, the server computing system 108 accesses the data store 114 to identify which ambient acoustic characteristics are associated with the location associated with the query, e.g., via the mapping. The server computing system 108 provides a response to the query that identifies the one or more ambient acoustic characteristics (258). In some examples, the server computing system 108 provides the response that identifies the ambient acoustic characteristics that are associated with the location of the query to the computing device 106 over the network 110.

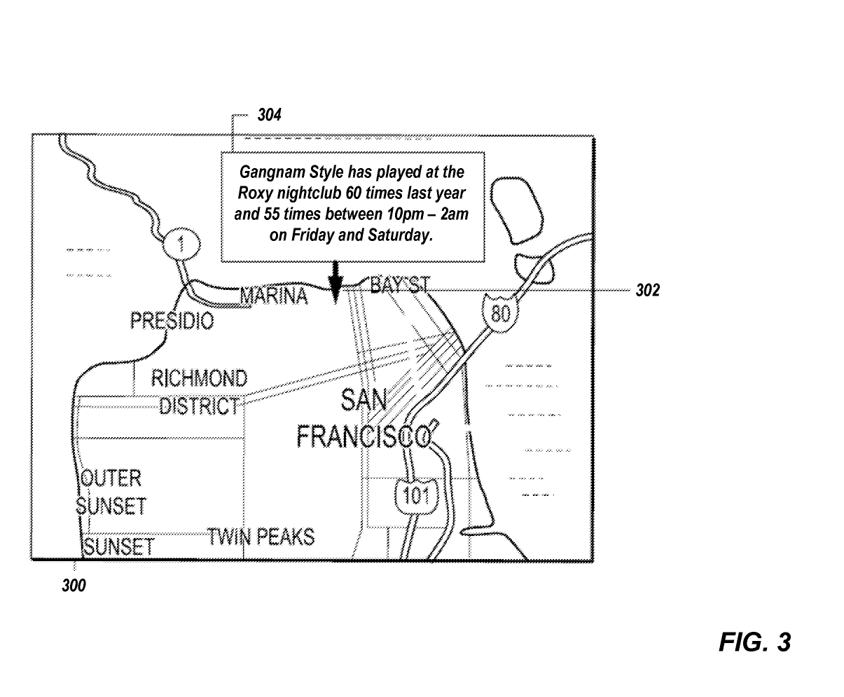

FIG. 3 illustrates an example of a map 300 of a geographic region that includes the location associated with the received query, e.g., from the computing device 106. As shown in FIG. 3, a map of San Francisco is provided to the computing device 106. The map 300 includes the location associated with the query designated by an arrow icon 302. Context information including the ambient acoustic characteristics of the location, e.g., in response to the query, are provided in a box 304. For example, as shown in FIG. 3, in response to the query “Does the Roxy nightclub play Gangnam Style,” the context information includes the count of times the song “Gangnam Style” has played at the location over the past year, and the count of times the song “Gangnam Style” has played between 10 pm-2 am on Friday and Saturday.

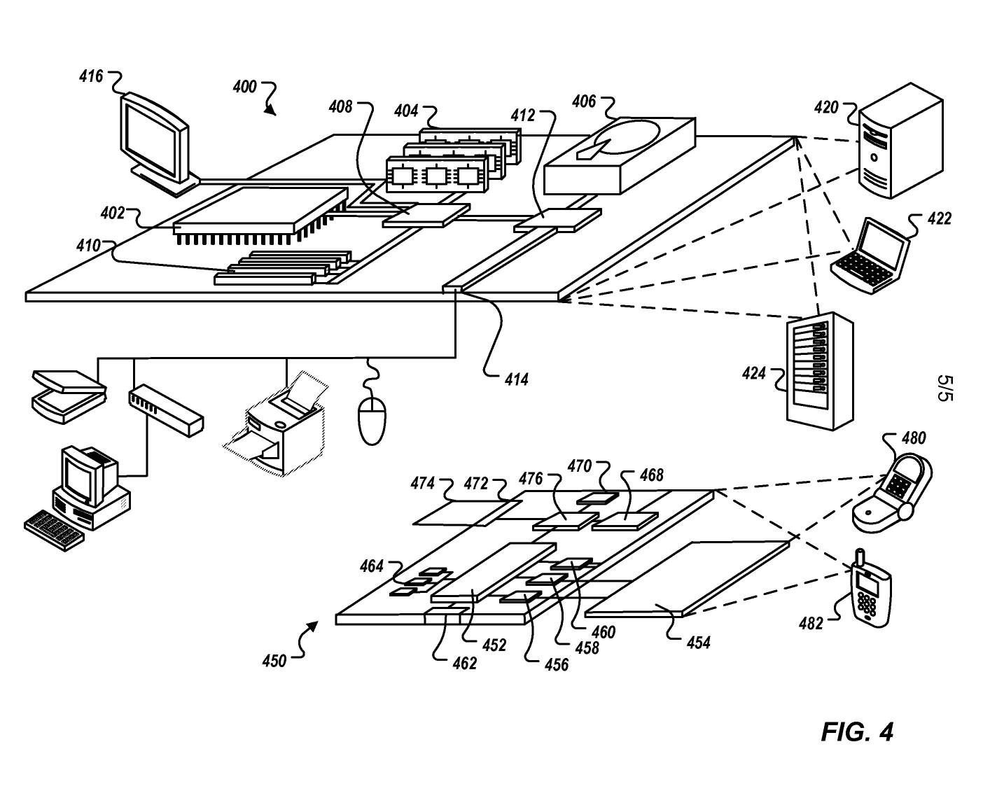

FIG. 4 shows an example of a generic computer device 400 and a generic mobile computer device 450, which can be used with the techniques described here. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and can be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses can be used, as appropriate, along with multiple memories and types of memory. Also, multiple computing devices 400 can be connected, with each device providing portions of the necessary operations (e.g., as a server bank, a group of blade servers, or a multi-processor system).

The memory 404 stores information within the computing device 400. In one implementation, the memory 404 is a volatile memory unit or units. In another implementation, the memory 404 is a non-volatile memory unit or units. The memory 404 can also be another form of computer-readable medium, such as a magnetic or optical disk.

The storage device 406 is capable of providing mass storage for the computing device 400. In one implementation, the storage device 406 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The information carrier is a computer- or machine-readable medium, such as the memory 404, the storage device 406, or a memory on processor 402.

The high speed controller 408 manages bandwidth-intensive operations for the computing device 400, while the low speed controller 412 manages lower bandwidth-intensive operations. Such allocation of functions is exemplary only. In one implementation, the high-speed controller 408 is coupled to memory 404, display 416 (e.g., through a graphics processor or accelerator), and to high-speed expansion ports 410, which can accept various expansion cards. In the implementation, low-speed controller 412 is coupled to storage device 406 and low-speed expansion port 414. The low-speed expansion port, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 400 can be implemented in a number of different forms, as shown in the figure. For example, it can be implemented as a standard server 420, or multiple times in a group of such servers. It can also be implemented as part of a rack server system 424. In addition, it can be implemented in a personal computer such as a laptop computer 422. Alternatively, components from computing device 400 can be combined with other components in a mobile device, such as device 450. Each of such devices can contain one or more of computing device 400, 450, and an entire system can be made up of multiple computing devices 400, 450 communicating with each other.

Computing device 450 includes a processor 452, memory 464, an input/output device such as a display 454, a communication interface 466, and a transceiver 468, among other components. The device 450 can also be provided with a storage device, such as a microdrive or other device, to provide additional storage. Each of the components 450, 452, 464, 454, 466, and 468, are interconnected using various buses, and several of the components can be mounted on a common motherboard or in other manners as appropriate.

The processor 452 can execute instructions within the computing device 640, including instructions stored in the memory 464. The processor can be implemented as a chipset of chips that include separate and multiple analog and digital processors. The processor can provide, for example, for coordination of the other components of the device 450, such as control of user interfaces, applications run by device 450, and wireless communication by device 450.

Processor 452 can communicate with a user through control interface 648 and display interface 456 coupled to a display 454. The display 454 can be, for example, a TFT LCD (Thin-Film-Transistor Liquid Crystal Display) or an OLED (Organic Light Emitting Diode) display, or other appropriate display technology. The display interface 456 can comprise appropriate circuitry for driving the display 454 to present graphical and other information to a user. The control interface 458 can receive commands from a user and convert them for submission to the processor 452. In addition, an external interface 462 can be provide in communication with processor 452, so as to enable near area communication of device 450 with other devices. External interface 462 can provide, for example, for wired communication in some implementations, or for wireless communication in other implementations, and multiple interfaces can also be used.

The memory 464 stores information within the computing device 450. The memory 464 can be implemented as one or more of a computer-readable medium or media, a volatile memory unit or units, or a non-volatile memory unit or units. Expansion memory 454 can also be provided and connected to device 450 through expansion interface 452, which can include, for example, a SIMM (Single In Line Memory Module) card interface. Such expansion memory 454 can provide extra storage space for device 450, or can also store applications or other information for device 450. Specifically, expansion memory 454 can include instructions to carry out or supplement the processes described above, and can include secure information also. Thus, for example, expansion memory 454 can be provide as a security module for device 450, and can be programmed with instructions that permit secure use of device 450. In addition, secure applications can be provided via the SIMM cards, along with additional information, such as placing identifying information on the SIMM card in a non-hackable manner.

The memory can include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 454, memory on processor 452, or a propagated signal that can be received, for example, over transceiver 468 or external interface 462.

Device 450 can communicate wirelessly through communication interface 466, which can include digital signal processing circuitry where necessary. Communication interface 466 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 468. In addition, short-range communication can occur, such as using a Bluetooth, WiFi, or other such transceiver. In addition, GPS (Global Positioning System) receiver module 450 can provide additional navigation- and location-related wireless data to device 450, which can be used as appropriate by applications running on device 450.

Device 450 can also communicate audibly using audio codec 460, which can receive spoken information from a user and convert it to usable digital information. Audio codec 460 can likewise generate audible sound for a user, such as through a speaker, e.g., in a handset of device 450. Such sound can include sound from voice telephone calls, can include recorded sound (e.g., voice messages, music files, etc.) and can also include sound generated by applications operating on device 450.

The computing device 450 can be implemented in a number of different forms, as shown in the figure. For example, it can be implemented as a cellular telephone 480. It can also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this disclosure includes some specifics, these should not be construed as limitations on the scope of the disclosure or of what can be claimed, but rather as descriptions of features of example implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results. A number of implementations have been described. Nevertheless, it will be understood that various modifications can be made without departing from the spirit and scope of the disclosure. For example, various forms of the flows shown above can be used, with steps re-ordered, added, or removed. Accordingly, other implementations are within the scope of the following claims.

1-5. (canceled)

6. A computer-implemented method comprising:
receiving, by a system of one or more computers and from a computing device, a query;
determining, by the system, a location associated with the query;
determining, by the system, to include, in a response to the query, an indication of the location associated with the query;
identifying, by the system, a count of a number of times that an ambient acoustic characteristic has been detected in ambient sounds recorded at the location associated with the query;
determining whether a value that is based on the count of the number of times that the ambient acoustic characteristic has been detected in ambient sounds recorded at the location associated with the query satisfies a criterion;
in response to determining that the value that is based on the count of the number of times that the ambient acoustic characteristic has been detected in ambient sounds recorded at the location associated with the query satisfies the criterion, supplementing the response to the query with an indication of the number of times that the ambient acoustic characteristic has been detected in ambient sounds recorded at the location associated with the query; and
providing, by the system and to the computing device, the response to the query that includes:
(i) the indication of the location associated with the query, and
(ii) the indication of the number of times that the ambient acoustic characteristic has been detected in ambient sounds recorded at the location associated with the query.

7. The computer-implemented method of claim 6, wherein:
the ambient acoustic characteristic is a song, a song artist, or a music genre; and
the count of the number of times that the ambient acoustic characteristic has been detected in ambient sounds recorded at the location associated with the query indicates a frequency at which (i) the song has been played at the location, (ii) songs by the song artist have been played at the location, or (iii) songs within the music genre have been played at the location.

8. The computer-implemented method of claim 7, wherein providing the response to the query comprises providing, for presentation by the computing device, a search result that includes:
(1) the indication of the location that is determined to be associated with the query, and
(2) the frequency at which the (i) the song has been played at the location, (ii) songs by the song artist have been played at the location, or (iii) songs within the music genre have been played at the location.

9-29. (canceled)

30. The computer-implemented method of claim 6, wherein the count indicates that the ambient acoustic characteristic has been detected in ambient sounds recorded at the location associated with the query multiple times.

31. The computer-implemented method of claim 6, further comprising:
receiving, by the system, an audio signal of an ambient sound recorded at the location associated with the query;
determining, using one or more audio signal recognition applications, that the audio signal of the ambient sound includes the ambient acoustic characteristic; and
based on determining that the audio signal of the ambient sound includes the ambient acoustic characteristic, incrementing the count of the number of times that the ambient acoustic characteristic has been detected in ambient sounds recorded at the location associated with the query.

32. The computer-implemented method of claim 6, wherein determining whether the value that is based on the count of the number of times that the ambient acoustic characteristic has been detected in ambient sounds recorded at the location associated with the query satisfies the criterion comprises comparing the value to a threshold value.

33. The computer-implemented method of claim 32, further comprising selecting the threshold value from among a plurality of threshold values based on identifying that the threshold value is assigned to the ambient acoustic characteristic, wherein the plurality of threshold values are respectively assigned to different ones of a plurality of ambient acoustic characteristics.

34. The computer-implemented method of claim 6, further comprising:
identifying, by the system, a second count of a number of times that a second ambient acoustic characteristic has been detected in ambient sounds recorded at the location associated with the query, wherein the second ambient acoustic characteristic is different from the ambient acoustic characteristic;
determining whether a second value that is based on the second count of the number of times that the second ambient acoustic characteristic has been detected in ambient sounds recorded at the location associated with the query satisifies a second criterion; and
in response to determining that the second value that is based on the second count of the number of times that the second ambient acoustic characteristic has been detected in ambient sounds recorded at the location associated with the query satisifies the second criterion, supplementing the response to the query with a second indication of the number of times that the second ambient acoustic characteristic has been detected in ambient sounds recorded at the location associated with the query.

35. The computer-implemented method of claim 34, wherein:
the criterion is a first threshold value that corresponds to the ambient acoustic characteristic;
the second criterion is a second threshold value that corresponds to the second ambient acoustic; and
the first threshold value is different from the second threshold value.

36. The computer-implemented method of claim 6, wherein providing the response to the query comprises transmitting, from the system and to the computing device, an instruction for the computing device to present, on a display of a map that identifies the location associated with the query, the indication of the number of times that the ambient acoustic characteristic has been detected in ambient sounds recorded at the location associated with the query.

37. The computer-implemented method of claim 6, further comprising:
receiving, by the system, a second query;
determining, by the system, a second location associated with the second query;
determining, by the system, to include, in a second response to the second query, an indication of the second location associated with the second query;
identifying, by the system, a second count of a number of times that the ambient acoustic characteristic has been detected in ambient sounds recorded at the second location associated with the second query;
determining whether a second value that is based on the second count of the number of times that the ambient acoustic characteristic has been detected in ambient sounds recorded at the second location associated with the second query satisfies the criterion; and
in response to determining that the second value that is based on the second count of the number of times that the ambient acoustic characteristic has been detected in ambient sounds recorded at the second location associated with the second query does not satisfy the criterion, selecting to not supplement the response to the second query with an indication of the number of times that the ambient acoustic characteristic has been detected in ambient sounds recorded at the second location associated with the second query.

38. The computer-implemented method of claim 6, further comprising determining a time interval associated with the query,
wherein identifying the count of the number of times that the ambient acoustic characteristic has been detected in ambient sounds recorded at the location associated with the query comprises counting occurrences of the ambient acoustic characteristic detected in ambient sounds recorded at the location within the time interval associated with the query, to the exclusion of occurrences of the ambient acoustic characteristic detected in ambient sounds recorded at the location outside of the time interval associated with the query.

39. A non-transitory computer-readable medium having instruction stored thereon that, when executed by a processing device, cause performance of operations comprising:
receiving a query;
determining a location associated with the query;
determining to include, in a response to the query, an indication of the location associated with the query;
identifying a count of a number of times that an ambient acoustic characteristic has been detected in ambient sounds recorded at the location associated with the query;
determining whether a value that is based on the count of the number of times that the ambient acoustic characteristic has been detected in ambient sounds recorded at the location associated with the query satisfies a criterion;
in response to determining that the value that is based on the count of the number of times that the ambient acoustic characteristic has been detected in ambient sounds recorded at the location associated with the query satisfies the criterion, supplementing the response to the query with an indication of the number of times that the ambient acoustic characteristic has been detected in ambient sounds recorded at the location associated with the query; and
providing, to the computing device, the response to the query that includes:
(i) the indication of the location associated with the query, and
(ii) the indication of the number of times that the ambient acoustic characteristic has been detected in ambient sounds recorded at the location associated with the query.

40. The computer-readable medium of claim 39, wherein the operations further comprise:
receiving an audio signal of an ambient sound recorded at the location associated with the query;
determining, using one or more audio signal recognition applications, that the audio signal of the ambient sound includes the ambient acoustic characteristic; and
based on determining that the audio signal of the ambient sound includes the ambient acoustic characteristic, incrementing the count of the number of times that the ambient acoustic characteristic has been detected in ambient sounds recorded at the location associated with the query.

41. The computer-readable medium of claim 39, wherein determining whether the value that is based on the count of the number of times that the ambient acoustic characteristic has been detected in ambient sounds recorded at the location associated with the query satisfies the criterion comprises comparing the value to a threshold value.

42. The computer-readable medium of claim 41, wherein the operations further comprise selecting the threshold value from among a plurality of threshold values based on identifying that the threshold value is assigned to the ambient acoustic characteristic, wherein the plurality of threshold values are respectively assigned to different ones of a plurality of ambient acoustic characteristics.

43. The computer-readable medium of claim 39, wherein the operations further comprise:
identifying a second count of a number of times that a second ambient acoustic characteristic has been detected in ambient sounds recorded at the location associated with the query, wherein the second ambient acoustic characteristic is different from the ambient acoustic characteristic;
determining whether a second value that is based on the second count of the number of times that the second ambient acoustic characteristic has been detected in ambient sounds recorded at the location associated with the query satisifies a second criterion; and
in response to determining that the second value that is based on the second count of the number of times that the second ambient acoustic characteristic has been detected in ambient sounds recorded at the location associated with the query satisifies the second criterion, supplementing the response to the query with a second indication of the number of times that the second ambient acoustic characteristic has been detected in ambient sounds recorded at the location associated with the query.

44. The computer-readable medium of claim 43, wherein:
the criterion is a first threshold value that corresponds to the ambient acoustic characteristic;
the second criterion is a second threshold value that corresponds to the second ambient acoustic; and
the first threshold value is different from the second threshold value.

45. The computer-readable medium of claim 39, wherein providing the response to the query comprises transmitting, to the computing device, an instruction for the computing device to present, on a display of a map that identifies the location associated with the query, the indication of the number of times that the ambient acoustic characteristic has been detected in ambient sounds recorded at the location associated with the query.

46. The computer-readable medium of claim 39, wherein the operations further comprise:
receiving a second query;
determining a second location associated with the second query;
determining to include, in a second response to the second query, an indication of the second location associated with the second query;
identifying a second count of a number of times that the ambient acoustic characteristic has been detected in ambient sounds recorded at the second location associated with the second query;
determining whether a second value that is based on the second count of the number of times that the ambient acoustic characteristic has been detected in ambient sounds recorded at the second location associated with the second query satisfies the criterion; and
in response to determining that the second value that is based on the second count of the number of times that the ambient acoustic characteristic has been detected in ambient sounds recorded at the second location associated with the second query does not satisfy the criterion, selecting to not supplement the response to the second query with an indication of the number of times that the ambient acoustic characteristic has been detected in ambient sounds recorded at the second location associated with the second query.

47. The computer-readable medium of claim 39, wherein the operations further comprise determining a time interval associated with the query,
wherein identifying the count of the number of times that the ambient acoustic characteristic has been detected in ambient sounds recorded at the location associated with the query comprises counting occurrences of the ambient acoustic characteristic detected in ambient sounds recorded at the location within the time interval associated with the query, to the exclusion of occurrences of the ambient acoustic characteristic detected in ambient sounds recorded at the location outside of the time interval associated with the query.
